(19) United States
(12) Patent Application Publication
(10) Pub. No.: US 2014/0241376 A1
(43) Pub. Date: Aug. 28, 2014

(54) Apparatus and Method for Controlling Transaction Flow in Integrated Circuits

(71) Applicant: APPLE INC., Cupertino, CA (US)

(72) Inventors: Deniz Balkan, Santa Clara, CA (US); Gurjeet S Saund, Saratoga, CA (US); Kevin C Wong, Los Altos, CA (US); Munetoshi Fukami, Newark, CA (US)

(73) Assignee: APPLE INC., Cupertino, CA (US)

(21) Appl. No.: 13/778,482

(22) Filed: Feb. 27, 2013

(51) Int. Cl. H04L 12/56

(52) U.S. Cl. CPC H04L 47/6275
USPC 370/429

(57) ABSTRACT

Various embodiments of a method and apparatus for controlling transaction flow in a communications fabric is disclosed. In one embodiment, an IC includes a communications fabric connecting multiple agents to one another. Each agent may include an interface coupling itself to at least one other agent. Each interface may include multiple queues for storing information corresponding to pending transactions. Also included in each interface is an arbitration unit and control logic. The control logic may determine which transactions are presented to the arbitration unit for arbitration. In one embodiment, the control logic may inhibit certain transactions from being presented to the arbitration unit so that other higher priority transactions may advance. In another embodiment, the control logic may reduce the priority level of some transactions for arbitration purposes to prevent the blocking of other higher priority transactions.

### BACKGROUND

1. Technical Field

This disclosure is directed to integrated circuits (IC's), and more particularly, to controlling the flow of transactions between agents of an IC.

2. Description of the Related Art

To prioritize some transactions over other transactions in the movement through an integrated circuit (IC) such as a system on chip (SoC) fabric, a quality-of-service (QoS) mechanism may be implemented such that an agent generating a transaction may also provide information representing the QoS associated with that transaction. In a typical scenario, arbiters and queues in the path of a memory request or transaction containing QoS information should be capable of processing that information or forwarding the information to a subsequent circuit which is then capable of processing it.

Arbitration in such an SoC may be based on QoS indicators, or more generally, priority levels. Thus some transactions may have a higher priority level than others. Generally speaking, an arbitration unit may allow a transaction having a higher priority level to advance over one with a lower priority level.

### SUMMARY

Various embodiments of a method and apparatus for controlling transaction flow in a communications fabric is disclosed. In one embodiment, an IC includes a communications fabric connecting multiple agents to one another. Each agent may include an interface coupling itself to at least one other agent. Each interface may include multiple queues for storing information corresponding to pending transactions. Also included in each interface is an arbitration unit and control logic. The control logic may determine which transactions are presented to the arbitration unit for arbitration. In one embodiment, the control logic may inhibit certain transactions from being presented to the arbitration unit so that other higher priority transactions may advance. In another embodiment, the control logic may reduce the priority level of some transactions for arbitration purposes to prevent the blocking of other higher priority transactions.

In one embodiment, an interface unit may include separate queues each assigned to one of a number of virtual channels. The virtual channels may include a real time virtual channel, a low latency virtual channel, and a bulk virtual channel. Transactions corresponding to these virtual channels (e.g., real time transactions for the real time channel) may be stored in corresponding queues. Multiple queues may be present for at least the real time virtual channels, if not all of the virtual channels. Each of the real time transactions may have one of a high, medium, or low priority. A control circuit may determine if the real time queue includes any real time high priority transactions at its head (i.e., if a real time high priority is the oldest transaction stored therein), and if so, inhibit real time medium and real time low at the heads of other queues associated with the real time virtual channel from being presented to the arbitration unit until the real time high priority transactions have been presented. If no real time high priority transactions are at the head of any of the real time queues, but real time medium transactions are at the head of at least one of the real time queues, real time low transactions at the head of any other ones of the real time queues may be inhibited from being presented to the arbitration unit. Real time high transactions may have a higher priority than any other transactions. Real time medium transactions may have a higher priority than real time low transaction and bulk transactions, but may be arbitrated with low latency transactions. Real time low transactions may be arbitrated with bulk transactions. In some embodiments, this scheme may be extended to non-real time transactions. For example, low latency and bulk transactions may be inhibited along with real time medium and real time low transactions when a real time high transaction is at the head of a queue. Similarly, if a low latency transaction is at the head of a queue, real time low and bulk transactions may be inhibited.

In another embodiment, first and second queues may each store transactions from different virtual channels, and thus may include real time, low latency, and bulk transactions. The queues may be operated on a first-in, first-out basis, and thus a transaction at the head of each queue may be provided to the arbitration unit for arbitration. In some cases, particularly if a non-real time transaction at the head of a queue is blocking a higher priority real time transaction, control logic may demote (in terms of priority level) a transaction at the head of the other queue. For example, if the head of a first queue is a bulk transaction and the head of the second queue is a real time medium priority transaction, the control logic may reduce the priority level of the transaction at the head of the second queue to a real time low priority transaction so that it may be arbitrated with the bulk transaction. This may allow the bulk transaction to pass sooner and thus prevent it from blocking higher priority real time transactions that are behind it in its respective queue.

### BRIEF DESCRIPTION OF THE DRAWINGS

The following detailed description makes reference to the accompanying drawings, which are now briefly described.

FIG. 1 is a block diagram of one embodiment of an IC having a communications fabric implemented thereon.

FIG. 2 is a block diagram illustrating the interfacing of two different agents in one embodiment of a communications fabric.

FIG. 3 is a block diagram of one embodiment of a transmit unit having separate queues for different virtual channels.

FIG. 4 is a flow diagram of one embodiment of a method for operating an interface using separate queues for different virtual channels.

FIG. 5 is a block diagram of one embodiment of an interface unit having queues that are not based on virtual channels.

FIG. 6 is a flow diagram of one embodiment of a method for operating an interface using queues not based on virtual channels.

FIG. 7 is a block diagram of an exemplary system.

While susceptible to various modifications and alternative forms, specific embodiments thereof are shown by way of example in the drawings and will herein be described in detail. It should be understood, however, that the drawings and detailed description thereto are not intended to be limiting to the particular form disclosed, but on the contrary, the intention is to cover all modifications, equivalents and alternatives falling within the spirit and scope of the disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

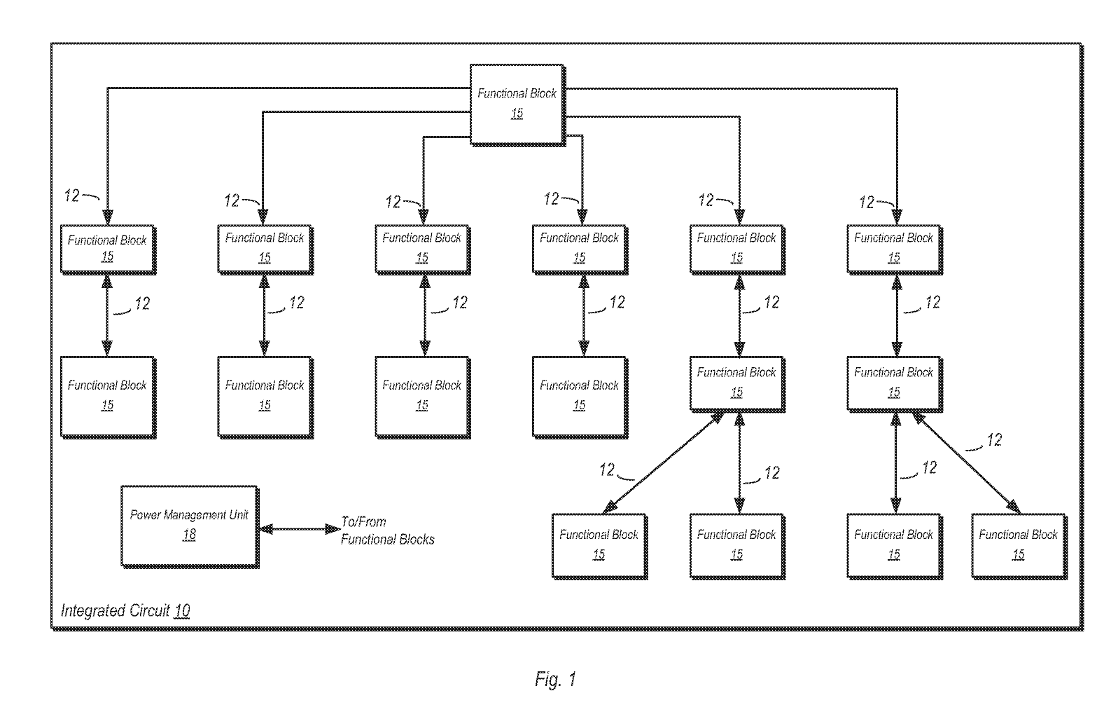

Turning now to FIG. 1, a block diagram of one embodiment of an integrated circuit (IC) is shown. In the embodiment shown, IC 10 includes a number of functional blocks 15. Each of the functional blocks 15 may be one of a number of different types of functional blocks, and may provide different functionality from at least some of the other functional blocks 15. For example, a number of processor cores, one or more graphics processors, one or more input/output (I/O) interfaces, and a memory controller may be included among the various instances of the functional blocks 15 shown in FIG. 1. The arrangement of IC 10 as shown herein is representative of one particular embodiment, although the various method and apparatus embodiments discussed below may be applied to a wide variety of ICs in various configurations and arrangements.

IC 10 in the embodiment shown also includes a power management unit 18, which is coupled to at least some, if not all, of functional blocks 15. Power management unit 18 may perform various actions to control the consumption of power by IC 10, such as clock gating individual functional blocks, power gating individual functional blocks and so on. Power management unit 18 may also change an operating clock frequency or an operating voltage of an individual functional block 15 in order to reduce its power usage while otherwise being active.

IC 10 may implement a communications fabric to enable communications between the various functional blocks 15. Each of the functional blocks 15 in the embodiment shown is coupled to at least one other functional block 15 by a communications link 12. In the embodiment shown, each communications link 12 is a point-to-point communications link, supporting communications between the pair of functional blocks 15 to which it is coupled. Moreover, each of the communications links 12 may support two-way communications between the two functional blocks 15 to which it is coupled. Functional blocks 15 that are coupled to one another by a given communications link 12 may be said to be logically adjacent to one another for the purposes of this disclosure. Thus, functional blocks 15 as shown in FIG. 1 may communicate directly with other functional blocks 15 that are logically adjacent thereto. For communications between two functional blocks 15 that are not logically adjacent to one another, communications may be routed through one or more intervening functional blocks.

Transactions in the communications fabric of IC 10 may be designated as one of a number of different types. In one embodiment, transactions may be classified as real time transactions, low latency transactions, or bulk transactions. Real time transactions may be defined as transactions having a guaranteed response time, or latency, i.e. the response time is within a given designated time frame. Real time transactions as discussed herein may have a variable priority level. In one embodiment, real time transactions may have a high, medium, or low priority level. Transactions that are not real time (low latency and bulk in this embodiment) may be defined as transactions for which a response time is not guaranteed. Low latency transactions may be further defined herein as transactions for which performance is improved when completed with lower latency. Bulk transactions may be defined herein as transactions for which performance is not dependent on the latency of completing the same. Both low latency and bulk transactions as defined herein may have fixed priority levels. Real time high priority transactions in the embodiment shown may have the highest priority over all other transaction types, but may be subject to arbitration when competing for resources with other real time high priority transactions. Real time medium transactions as defined herein may have priority over real time low transactions and bulk transactions, but may be subject to arbitration when competing for resources with low latency transactions. Real time low priority transactions as defined herein may be subject to arbitration with bulk transactions. As previously noted, the priority of real time transactions is variable and may thus be changed between a point of origin and a point of destination.

It is noted that communications links implemented as shared buses are also possible and contemplated, and such buses may support implementation of various features discussed below.

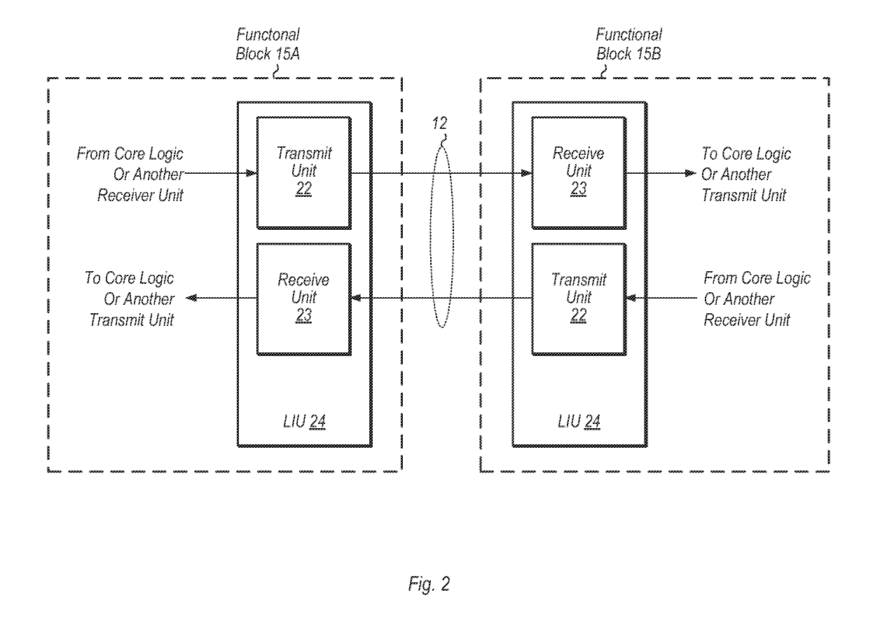

FIG. 2 a block diagram illustrating the interfacing of two different agents in one embodiment of a communications fabric. In the embodiment shown, functional block 15A is coupled to function block 15B via a communications link 12. Each of functional blocks 15A and 15B include a link interface unit (LIU) 24. It is noted that although functional blocks 15A and 15B in this example are each shown having only one LIU 24, in practice, a functional block may have as many instances of an LIU 24 as there are communications links coupled thereto.

Each LIU 24 in the embodiment shown includes a transmit unit 22 and a receiver unit 23. The receive unit 23 of each LIU 24 may receive data from a transmit unit 22 of a correspondingly coupled LIU 24 in another functional block. Data received by a receive unit 23 may be conveyed to the core logic of its corresponding functional block or to a transmit unit 22 in another LIU 24 of the same functional block 15. Data may be conveyed to the core logic when the corresponding functional block 15 is the final destination (or target) of a particular transaction received by a receive unit 23. When the corresponding functional block 15 is an intermediate point for a received transaction, its corresponding data may be conveyed to a transmit unit 22 in another LIU 24 in the same instance of functional block 15.

Each transmit unit 22 in the embodiment shown is coupled to receive data from either the core logic of its respective functional block 15, or from a receive unit 23 of another LIU 24 in that functional block 15. Each transmit unit 22 may transmit data, in the form of transactions, to a receive unit 23 of an LIU 24 in another functional block 15. The transactions may be arranged as packets, frames, or any other suitable form. Each of the transmit units 22 may include circuitry for storing pending transactions and associated information, as well as circuitry for arbitrating between pending transactions. Various embodiments of circuitry for controlling the flow of transactions transmitted from an LIU are discussed below.

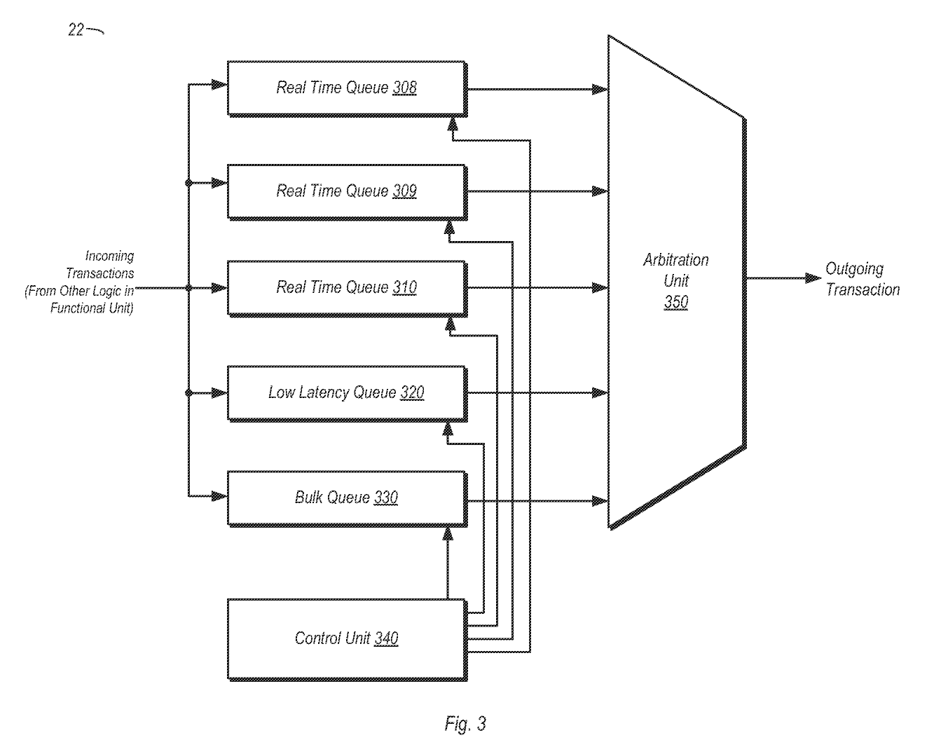

Turning now to FIG. 3, a block diagram of one embodiment of circuitry for controlling the flow of transactions is shown. In the embodiment shown, transmit unit 22 includes a number of separate queues that are based on different virtual channels. The virtual channels include three real time virtual channels, a low latency virtual channel, and a bulk virtual channel. Correspondingly, the queues included in transmit unit 22 includes real time queues 308, 309, and 310, a low latency queue 320, and bulk queue 330. Each of real time queues 308, 309, and 310 in the embodiment shown may store information associated with any real time high, medium, and/or low priority transactions. Low latency queue 320 stores information associated with low latency transactions. Bulk queue 330 stores information associated with bulk transactions. In some embodiments, multiple low latency queues and/or multiple bulk queues may be present. It is noted that the information associated with transactions stored in the various queues may include the transaction payload itself in some embodiments. In other embodiments, the information stored in the queues may be limited to routing and other information, while the payload for each transaction may be stored elsewhere within the transmit unit 22, corresponding link interface unit 24, or corresponding functional block 15. It is noted that each of the queues in this embodiment are implemented as first-in, first-out (FIFO) memories. It is also noted that while the embodiment shown includes only one low latency queue, and one bulk queue, embodiments having multiple instances of each of these queue types are possible and contemplated.

Each of the queues is coupled to provide transaction information to an arbitration unit 350. During a given cycle of operation for one embodiment of transmit unit 22, transactions may be conveyed from various ones of the queues to arbitration unit 350. The transaction received by arbitration unit 350 may be conveyed from the head of each queue (i.e., the oldest transaction in each queue, which are implemented as FIFOs). Arbitration unit 350 may arbitrate between the received transactions to determine the next one to be serviced, and thus transmitted from transmit unit 22. Arbitration unit 350 may use any suitable arbitration scheme, such as round-robin, weighted arbitration, age-based arbitration, and so on, as well as arbitration schemes that combine one or more arbitration types.

Control unit 340 in the embodiment shown is coupled to each of the queues. The transactions conveyed to arbitration unit 350 may be selected by control unit 340. More particularly, control unit 340 is coupled to determine which transactions are at the head of each of the queues, and may determine whether these transactions may be forwarded to arbitration unit 350 during a given cycle. Control unit 340 may use various selection criteria to determine which transactions are selected from the various queues. In one embodiment, the selection criteria may be based on credits applied to each queue, which are factored in when control unit 340 is determining which queues from which to select transactions for the next arbitration cycle. However, any suitable criteria to ensure forward progress for transactions in each of the queues may be used.

As previously noted, real time high priority transactions have priority over all other transactions. Real time medium priority transactions may have the same priority (and thus be arbitrated with) low latency transactions, while real time low priority transactions have the same priority (and may thus be arbitrated with) bulk transactions. In some cases, such as in a credit based system, a transaction at the head of a queue might not be selected for a lack of credits or other reason. This may prevent the forward progress of some transactions and could thus adversely impact performance, particularly with real time transactions, which are to be completed within a guaranteed time frame. However, in the embodiment shown, control unit 340 may nevertheless be configured to override the selection criteria to allow some real time transactions to advance.

Control unit 340 in the embodiment shown is configured to determine which transactions are present at the head of each of the queues. If control unit 340 determines that any real time high priority transactions are at the head of at least one of the real time queues, it may inhibit real time medium priority and real time low priority transactions from being forwarded to arbitration unit 350 if such transactions are at the head of other real time queues. This may allow the real time high priority transactions to advance and thus to be completed within their designated time frame. In the case that real time medium priority transactions are at the head of a real time queue but while no real time high priority transactions at the head of another real time queue, control unit 340 may inhibit real time low priority transactions that are also at the head of a real time queue from being forwarded to arbitration unit 350. The real time medium transactions may be forwarded to arbitration unit 350. Arbitration unit 350 may arbitrate between the real time medium transactions and low latency transactions if present during the same cycle of arbitration. The real time medium transactions may be advanced over any bulk transactions presented to arbitration unit 350 during the same arbitration cycle.

In this manner, if a real time high transaction cannot be chosen by the arbiter for some reason (e.g., due to a lack of credits in a credit-based system), real time medium/low and low latency/bulk transactions are not presented to the arbitration unit and thus are not chosen to be forwarded even if they are otherwise eligible. This may in turn prevent lower priority transactions from occupying system resources, thereby allowing the higher priority transactions to make progress once they are eligible to be chosen by the arbiter.

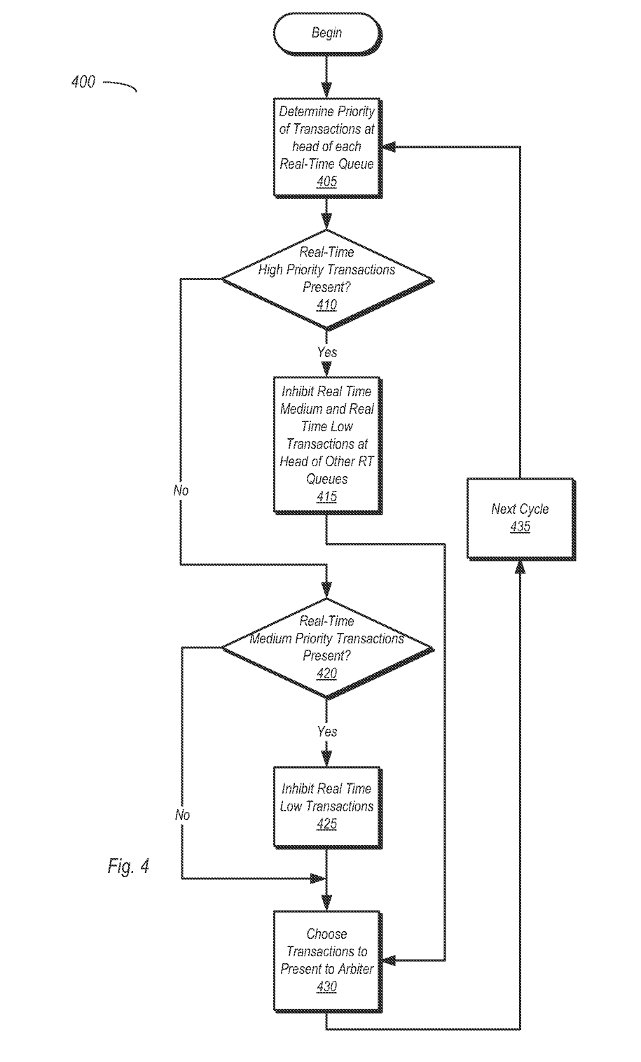

FIG. 4 is a flow diagram illustrating one embodiment of a method for operating an interface using separate queues for different virtual channels. More particularly, method 400 may be utilized by hardware such as that shown in FIG. 3, although other hardware embodiments may also implement the methodology described herein. Similarly, software and firmware embodiments that implement the methodology are also possible and contemplated, as well as various combinations of hardware, software, and/or firmware.

Method 400 begins with the determining the priority of transactions at the head of each of the real time queues (block 405). For example, control unit 340 as shown in FIG. 3 may take an inventory of transactions stored in real time queue 310, determining the number of real time high priority transactions, the number of real time medium priority transactions, and the number of low priority transactions. If one or more real time transactions high are present at the head of the various real time queues (block 410, yes), then the control unit may for that cycle inhibit real time medium and real time low transactions from being forwarded to the arbitration unit (block 415). In some embodiments, low latency and bulk transactions may also be inhibited from being forwarded to the arbitration unit. This inhibiting of real time medium and real time low transactions (as well as low latency and bulk transactions in some embodiments) may occur even though such transactions may have been present at the head of respective real time queues for a greater duration than the real time high priority transactions. This may enable the real time high priority transactions to advance once they are eligible.

If no real time high priority transactions are present at the head of any real time queues (block 410, no), method 400 advances to block 420. If real time medium priority transactions are present at the head of any of the real time queues (block 420, yes), then real time low priority transactions also at the head of a real time queue may be inhibited from advancing to the arbitration unit (block 425). In some embodiments, bulk transactions may also be inhibited from advancing to the arbitration unit. Real time medium transactions may, when eligible, be advanced to the arbitration unit, where they may be arbitrated against low latency transactions or advanced ahead of bulk transactions. If no real time medium transactions are present the method advances to block 430. In block 430, the control unit may select transactions from the heads of the various queues for presentation to the arbitration unit. The arbitration unit may then arbitrate between the transactions presented thereto, and inform the control unit of the arbitration outcome. Method 400 may then advance to the next cycle (block 435), and thus return to block 405.

In some embodiments, the scheme may also be extended to non-real time transactions. For example, if a low latency transaction is at the head of a queue, real time low and bulk transactions may be inhibited. The low latency transaction may then advance to the arbitration unit when eligible.

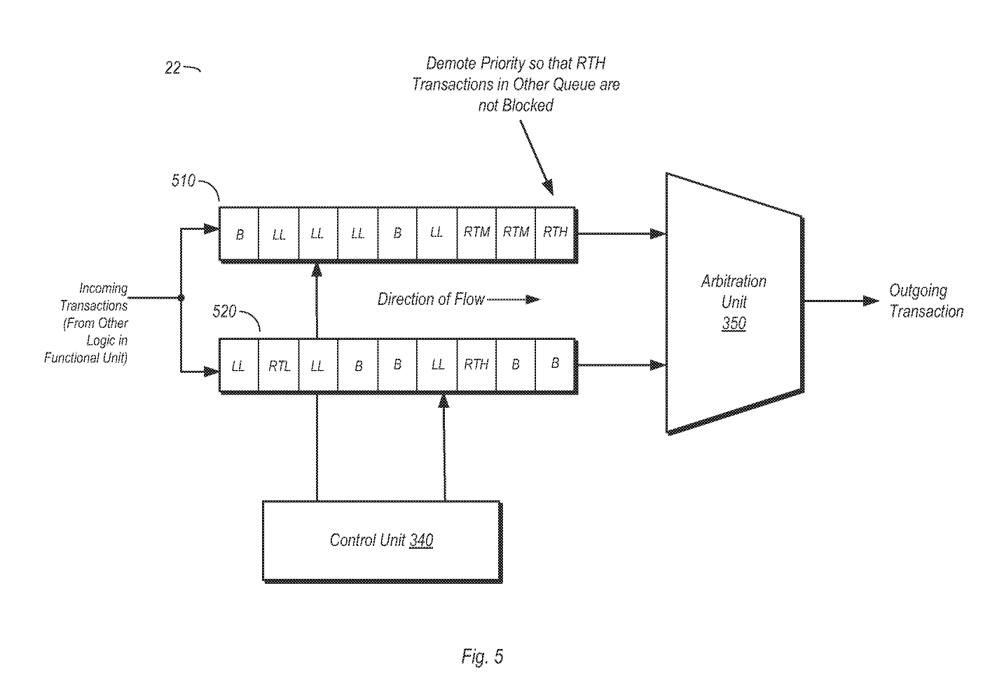

FIG. 5 illustrates another embodiment of circuitry for controlling the flow of transactions. In this particular embodiment, the queues do not correspond to virtual channels. Instead, transmit unit 22 in the embodiment shown includes a first queue 510 and a second queue 520. Each of the queues may store information for real time transactions of any priority, for low latency transactions, and for bulk transactions. Each of queues 510 and 520 may be arranged as FIFO memories. Since arbitration unit 350 in the embodiment shown will advance only one transaction per arbitration cycle, only one FIFO location is freed per arbitration cycle. Accordingly, incoming transactions may be stored in the queue having a free position as a result of a transaction therefrom advancing.

Since both queues are arranged as FIFOs in this embodiment, a transaction at the head of each queue is provided to arbitration unit 350 for arbitration during each cycle. The head of a queue may be defined in this example as being the location storing the oldest transaction in that queue (i.e. the first transaction stored therein from all transactions within that queue). In the illustrated example, the transactions will advance in the indicated direction of flow, with the older transactions toward the right and the newer transactions toward the left. It is noted that this example is not intended to imply a physical arrangement, but rather a logical arrangement. Thus, a given physical storage location in a given queue may logically be at the head of the queue when it is storing the oldest transaction therein, but is otherwise not logically at the head of the queue.

Control unit 340 may maintain a record of the priority level each transaction stored in queues 510 and 520, along with a record of the ordering of these transactions. The record may be updated each time a transaction is advanced and a new transaction is written into a queue. As previously noted, the priority of real time transactions is variable and may thus be changed in some cases. In the embodiment shown, control unit 340 is configured to change the priority of real time transactions if it is necessary to allow other real time transactions to advance in a timely manner. In particular, control unit 340 may change the priority of some real time transaction in order to prevent the blocking of other real time transactions.

In the example shown in the three oldest transactions in queue 510 are real time transactions, including a real time high transaction at the head of the queue followed by two real time medium transactions. A low latency transaction follows the real time medium transaction. In queue 520, a bulk transaction is at the head of the queue, followed by another bulk transaction, and then followed by a real time high priority transaction. Because of the arrangement shown, the real time high transaction shown in queue 520 may be blocked from advancement for a certain amount of time due to the presence of the bulk transaction at the head of queue 520 and the real time and low latency transactions in the oldest positions of queue 510. If the priorities are left unchanged, each of the first three real time transactions in queue 510, plus the oldest low latency transaction, will all advance through arbitration unit 350 before the bulk transaction at the head of queue 520 can be arbitrated with another transaction of equal priority (which, in this case, is the oldest bulk transaction in queue 510). Thus, the real time high transaction may be prevented from advancing at least until the real time and low latency transactions have been cleared from the four oldest positions of queue 510. Furthermore, the real time high priority transaction in queue 520 may be further delayed until the bulk transaction in the second position also advances.

In order to reduce the delay of the real time high transaction in queue 520, control unit 340 may reduce the priority level of the real time transaction at the head of queue 510. For example, control unit 340 may reduce the priority of the real time high transaction at the head of queue 510 to real time low priority, and then present the transactions at the heads of each queue to arbitration unit 350. Since real time low transactions have equal priority to bulk transactions, the bulk transaction at the head of queue 520 has a chance of winning the arbitration and advancing. Similarly, the real time medium priority transactions following the real time high transaction in queue 510 may also have their respective priorities reduced to real time low when they reach the head of the queue. This in turn increases the probability that the real time high transaction in the third position of queue 520 will reach the head of queue 520 and thus advance.

Thus, control unit 340 may reduce the priority level of a real time high priority transaction at the head of a queue to real time medium or real time low priority in order to enable the advancement of a real time transaction in the other queue. Similarly, a real time medium priority transaction at the head of one queue may have its priority reduced to real time low by control unit 340 in situation where a bulk transaction is blocking another real time transaction in the other queue. In general, control unit 340 may alter the priority of any real time transaction at the head of a queue in any manner that can prevent the blocking of other real time transactions that are not at the head of a queue. This in turn may enable real time transactions to be completed within their guaranteed time frames. Embodiments are also possible and contemplated wherein control unit 340 may at times present transactions to arbitration unit 350 out of order if necessary to prevent real time transactions from being blocked.

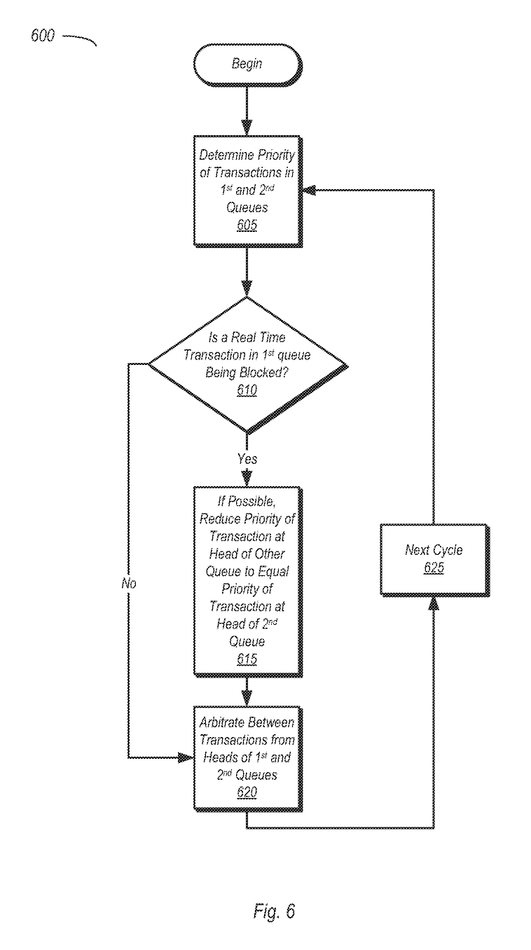

FIG. 6 is a flow diagram of one embodiment of a method for operating an interface using queues not based on virtual channels. Method 600 as shown in FIG. 6 may be performed by hardware embodiment shown in FIG. 5, as well as any other hardware, software, or firmware embodiment (or combinations thereof) that can control the flow of transactions in the manner illustrated therein. Thus, while method 600 is explained in the context of the apparatus shown in FIG. 5, this discussion is not intended to be limiting to that particular embodiment.

Method 600 begins with a control unit determining the priority of transactions stored in first and second queues (block 605). More particularly, the control unit may determine the priority of each transaction stored in one of the queues, as well as the ordering thereof, may be determined by the control unit. After determining the priority and ordering of the transactions in each of the queues, the control unit may determine if a real time transaction in a first queue is being blocked by one or more other transactions in the first queue (block 610). For example, as shown in the example of queue 520 in FIG. 5, the control unit may determine if one or more bulk transactions are blocking a real time high priority transaction.

If no real time transactions are being blocked (block 610, no), then the transactions at the head of each of the queues may be presented to the arbitration unit (block 620), where they may be arbitrated if they have equal priority with one another (e.g., when a real time medium transaction and a low latency transaction are presented to the arbiter). In some cases, a transaction at the head of one queue will have a higher priority than the transaction at the head of the other queue (e.g., when a real time medium and a bulk transaction are presented to the arbitration unit). In such cases, the transaction having the higher priority will win the arbitration by default. The transaction that loses the arbitration may then be presented to the arbitration unit during the next arbitration cycle.

If the control unit determines that a real time transaction is being blocked in one queue and a real time transaction is at the head of the other queue (block 610, yes), it may reduce the priority of the real time transaction at the head of the other queue (block 615). For example, a real time high transaction at the head of one queue may have its priority reduced to real time medium if a low latency transaction is at the head of the other queue (i.e. the queue in which the real time transaction is blocked). A real time high or real time medium transaction at the head of one queue may have its priority reduced to real time low if a bulk transaction at the head of the other queue is blocking a real time transaction. Thereafter, the transactions at the head of each queue may be presented to the arbitration unit and arbitrated as equals (block 620). After the arbitration is complete, method 600 proceeds to the next cycle (block 625) and thus back to the determining of the priority and ordering of each of the transactions stored in first and second queues.

While the virtual channels that have been discussed herein in terms of real time and non-real time virtual channels, embodiments utilizing other designations for virtual channels are also possible and contemplated. Furthermore, while a particular priority scheme has been discussed herein (e.g., real time high, medium and low transactions), other priority schemes are also possible within the scope of this disclosure.

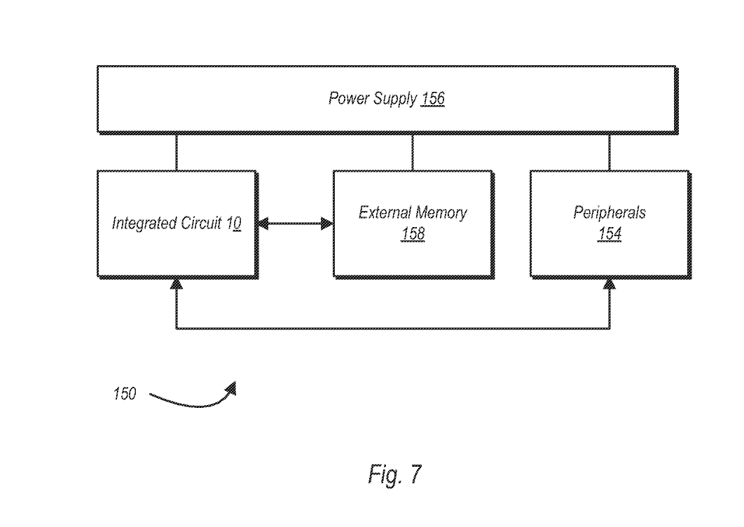

Turning next to FIG. 7, a block diagram of one embodiment of a system 150 is shown. In the illustrated embodiment, the system 150 includes at least one instance of the integrated circuit 10 coupled to external memory 158. The integrated circuit 10 is coupled to one or more peripherals 154 and the external memory 158. A power supply 156 is also provided which supplies the supply voltages to the integrated circuit 10 as well as one or more supply voltages to the memory 158 and/or the peripherals 154. In some embodiments, more than one instance of the integrated circuit 10 may be included (and more than one external memory 158 may be included as well).

The peripherals 154 may include any desired circuitry, depending on the type of system 150. For example, in one embodiment, the system 150 may be a mobile device (e.g. personal digital assistant (PDA), smart phone, etc.) and the peripherals 154 may include devices for various types of wireless communication, such as WiFi, Bluetooth, cellular, global positioning system, etc. The peripherals 154 may also include additional storage, including RAM storage, solid-state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, LPDDR1, LPDDR2, etc.) SDRAM, RAMBUS DRAM, etc. The external memory 158 may include one or more memory modules to which the memory devices are mounted, such as single inline memory modules (SIMMs), dual inline memory modules (DIMMs), etc.

Numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of queues, wherein the plurality of queues includes two or more queues configured to store information for transactions associated with a real time virtual channel and one or more queues configured to store transactions for corresponding non-real time channels;
an arbitration unit configured to arbitrate between transactions received from two or more of the plurality of queues; and
control logic configured to select transactions to be presented to the arbitration unit, wherein the control logic is configured to select transactions at a head of each queue from which transactions are selected, wherein a transaction at the head of each queue is an oldest transaction stored in that queue, and wherein the control logic is further configured to inhibit lower priority real time transactions from being presented from one of the queues associated with the real time virtual channel to the arbitration unit responsive to determining that a higher priority real time transaction is at the head of another one of the queues associated with the real time virtual channel.

2. The apparatus as recited in claim 1, wherein the control logic is configured to inhibit real time medium priority transaction and real time low priority transactions from being provided to the arbitration unit responsive to determining that information associated with a real time high priority transaction is at the head of one of the queues associated with the real time virtual channel.

3. The apparatus as recited in claim 2, wherein the control logic is configured to inhibit real time low priority transactions from being provided to the arbitration unit responsive to determining that information associated with a real time medium priority transaction is at a head of one of the queues associated with the real time virtual channel.

4. The apparatus as recited in claim 3, wherein the control logic is configured to cause information corresponding to the real time medium priority transaction to be presented to the arbitration unit from one of the queues associated with the real time virtual channel responsive to determining that no information corresponding to a real time high priority transaction is at a head of another one of the queues associated with the real time virtual channel.

5. The apparatus as recited in claim 4, wherein the arbitration unit is configured to cause a real time high priority transaction to be advanced when arbitrated against another transaction that is not a real time high priority transaction, and wherein the arbitration unit is further configured to:
arbitrate between a transaction that is a real time medium priority transaction and a transaction designated as a low latency transaction; and
arbitrate between a transaction that is a real time low priority transaction and a transaction designated as a bulk transaction.

6. The apparatus as recited in claim 1, wherein the plurality of queues includes a first queue associated with a first non-real time channel and a second queue associated with a second non-real time channel.

7. The apparatus as recited in claim 6, wherein the first non-real time channel is a low latency channel configured to convey low latency transactions, and wherein the second non-real time channel is a bulk channel configured to convey bulk transactions.

8. The apparatus as recited in claim 7, wherein the low latency transactions have a greater priority than the bulk transactions.

9. The apparatus as recited in claim 7, wherein the arbitration unit is configured to:
forward a real time high priority transactions over all other transactions;
arbitrate between real time medium priority transactions and low latency transactions;
arbitrate between real time low priority transactions and bulk transactions.

10. A method comprising:
storing, in a first queue, transactions associated with a real time virtual channel;
storing, in a second queue, transactions associated with the real time virtual channel;
storing, in a third queue, transactions associated with a non-real time virtual channel; and
selecting transactions from the first second, and third queues to be presented to an arbitration unit, wherein said selecting includes selecting oldest transaction stored in each of the queues from which transactions are selected, and wherein said selecting further includes inhibiting a real time transaction having a first priority from being presented to the arbitration unit from one of the first and second queues responsive to determining that a real time transaction having a second priority is an oldest transaction in the other one of the first and second queues, wherein the second priority is higher than the first priority.

11. The method as recited in claim 9, further comprising arbitrating transactions in the arbitration unit, wherein said arbitrating includes arbitrating between transactions received from at least two of the first, second, and third queues.

12. The method as recited in claim 9, wherein the second priority is a high priority, wherein the first priority is a medium priority, and wherein a third priority is a low priority, and wherein the method further comprises advancing real time transactions having a high priority over real time transactions have a low priority or a medium priority.

13. The method as recited in claim 12, further comprising:
arbitrating between a medium real time transaction and a non-real time transaction designated as a low latency transaction; and
arbitrating between a low priority real time transaction and a non-real time transaction designated as a bulk transaction.

14. The method as recited in claim 23, wherein said selecting further comprises inhibiting a low priority real time transaction responsive to determining that at least one real time transaction of the high or medium priority is present at the head of at least one of the first and second queues.

15. An apparatus comprising:
a first queue configured to store information for transactions of a first plurality of transactions;
a second queue configured to store information for transactions of a second plurality of transactions, wherein the first and second pluralities of transactions include real time transaction and non-real time transactions;
an arbitration unit configured to arbitrate between transactions presented from the first queue and the second queue; and
control logic configured to select transactions to be presented to the arbitration unit, wherein the control logic is configured to select which of the first and second pluralities of transactions are presented to the arbitration unit, and further configured to reduce a priority of a first transaction at a head of the first queue responsive to determining that a high priority transaction is blocked by a lower priority transaction at a head of the second queue.

16. The apparatus as recited in claim 15, wherein each of the first and second queues are configured to store real time transactions and non-real time transactions.

17. The apparatus as recited in claim 15, wherein the control logic is configured to provide for arbitration to the arbitration unit a first transaction from a head of the first queue and a second transaction from a head of the second queue.

18. The apparatus as recited in claim 17, wherein the control logic is configured to reduce a priority level of a real time transaction at the head of the first queue from a high priority to a medium priority responsive to determining the presence of a low latency transaction at the head of the second queue and the presence of one or more real time high priority transactions in the second queue.

19. The apparatus as recited in claim 17, wherein the control logic is configured to reduce a priority level of a real time transaction at the head of the first queue to a low priority responsive to determining the presence of a bulk transaction at the head of the second queue and one or more real time high or medium transactions in the second queue.

20. The apparatus as recited in claim 15, wherein each of the first and second queues is configured to store real time transactions, low latency transactions, and bulk transactions, and wherein the arbitration unit is configured to:
arbitrate between a transaction that is a real time medium priority transaction and a transaction designated as a low latency transaction; and
arbitrate between a transaction that is a real time low priority transaction and a transaction designated as a bulk transaction.
